(19) United States
(12) Patent Application Publication
(10) Pub. No.: US 2026/0029539 A1
(43) Pub. Date: Jan. 29, 2026

(54) Angel Finders LLC

(71) Applicant: Ethel Renee Faulkner, Chicago, IL (US)

(72) Inventor: Ethel Renee Faulkner, Chicago, IL (US)

(21) Appl. No.: 18/772,136

(22) Filed: Jul. 29, 2024

(51) Int. Cl. G01S 19/14; G06F 16/29; G06F 16/9537

(52) U.S. Cl. CPC G01S 19/14; G06F 16/29; G06F 16/9537

(57) ABSTRACT

This invention relates to a compact GPS tracking device designed for real-time location monitoring, particularly for locating loved ones' gravesites. The device features a solar-powered battery for extended usage in outdoor environments, with a waterproof casing to ensure durability under various weather conditions. It includes a SIM card slot for mobile network connectivity, enabling remote tracking through a mobile application. The GPS unit provides precise location data while optimizing for low power consumption, ensuring longer battery life. A user-friendly power button allows for manual activation. The device's small and portable design makes it ideal for personal, vehicle, asset, and memorial tracking applications, offering peace of mind in maintaining the location of important sites.

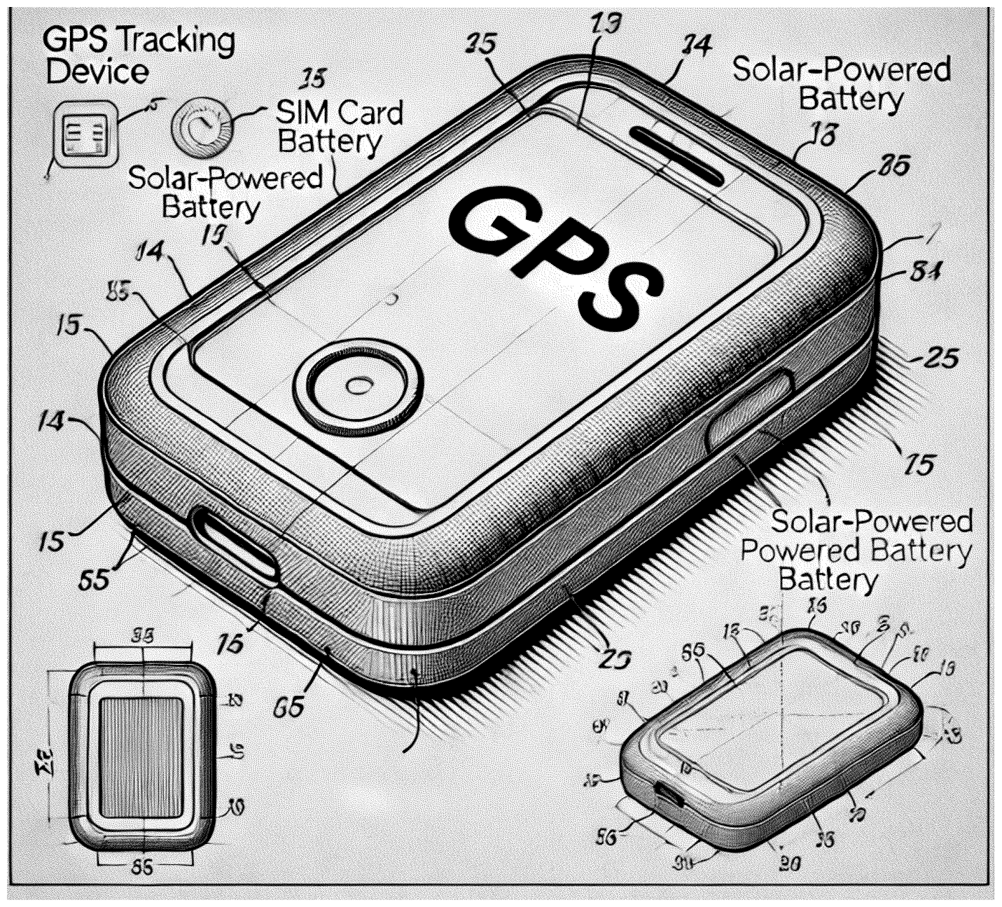

### BACKGROUND OF THE INVENTION

In March 2014, Renee Faulkner, the inventor, and her family experienced significant difficulties in locating her mother's final resting place at a cemetery. The lack of established headstone and absence of written procedures for locating unmarked graves caused frustration and confusion. This problem was not unique to Renee's family, as they discovered that other families were also struggling to find their loved ones' graves. In response to this issue, Renee and her partner Courtney devised a solution—Angel Finder, a GPS tracker system that provides peace of mind by accurately locating the final resting place of loved ones.

### SUMMARY OF THE INVENTION

Angel Finders is a GPS tracker system specifically designed for use in cemeteries. It is intended to assist individuals in locating the exact burial site of their loved ones, even in cases where there are no established headstones or written procedures for locating unmarked graves. By utilizing cutting-edge GPS technology, Angel Finder ensures precise and reliable information regarding the location of a grave.

### DESCRIPTION OF THE INVENTION

1. GPS Tracking Device: Angel Finders consists of a small, discreet GPS tracking device that can be easily attached to a headstone or placed near the burial site.
2. Cemetery Database Integration: The GPS tracking device is connected to a centralized cemetery database that stores the coordinates of each grave.
3. User-Friendly Mobile Application: Angel Finders provides a user-friendly mobile application that allows individuals to access the cemetery database and receive real-time location information.

### Exhibit 1

4. Interactive Cemetery Directory: The mobile application features an interactive cemetery directory, enabling users to search for specific names or browse through the cemetery map.
5. Customized Notifications: Angel Finders sends customized notifications to users, alerting them when they are approaching their loved one's grave.
6. Battery Efficiency: The GPS tracking device is designed to operate efficiently, ensuring long battery life to minimize maintenance requirements.
7. Privacy and Security: Angel Finders prioritizes the privacy and security of user data, implementing robust encryption protocols and strict access controls.

### Advantages of the Invention

1. Accurate and Reliable: Angel Finders utilizes GPS technology to provide precise and reliable location information, eliminating the need for guesswork or reliance on cemetery staff.
2. Peace of Mind: The system offers emotional comfort and peace of mind, allowing individuals to easily visit and honor their loved ones' final resting place.
3. Time and Cost Savings: Angel Finders minimizes the time spent searching for graves, reducing stress and avoiding additional expenses associated with locating unmarked graves.
4. Accessibility: The mobile application ensures easy access for individuals of all ages and technological proficiency levels.
5. Scalability: The system is scalable and can be implemented in cemeteries of various sizes, accommodating the needs of different communities

### Conclusion

Angel Finders is a revolutionary GPS tracker system that addresses the challenges faced by individuals searching for unmarked graves in cemeteries. With its accurate location information and user-friendly mobile application, Angel Finders provides peace of mind and facilitates the process of paying respects to loved ones.

### Exhibit 1A

### Step-by-Step Guide on How to Use Angel Finders:

1. Attach the GPS tracking device: Attach the small, discreet GPS tracking device to a headstone or place it near the burial site. Ensure that it is securely fastened and will not be easily moved or damaged.
2. Download the mobile application: Search for the Angel Finders mobile application in your device's app store and download it. The app is available for both iOS and Android devices.
3. Create an account: Open the app and create an account using your email address and a secure password. Follow the prompts to complete the account creation process.
4. Connect the GPS tracking device: Once your account is set up, follow the instructions provided in the app to connect the GPS tracking device to your account. This may involve scanning a QR code or entering a unique identifier.
5. Access the cemetery database: Once the GPS tracking device is connected, you can access the cemetery database through the mobile application. The database will contain the coordinates of each grave.
6. Search for your loved one's grave: Use the interactive cemetery directory in the app to search for your loved one's grave. You can enter their name in the search bar or browse through the cemetery map to locate the specific area.
7. Receive real-time location information: Once you have found the grave, the app will provide real-time location information. It may show the distance to the grave or provide a map with a pin indicating the exact location.

### Exhibit 2

8. Set up customized notifications: In the app settings, you can set up customized notifications to receive alerts when you are approaching your loved one's grave. This can help you navigate the cemetery more easily and ensure you are in the right area.
9. Maintain the GPS tracking device: The GPS tracking device is designed to operate efficiently and has a long battery life. However, it is important to regularly check the device's battery level and ensure it is functioning properly. If needed, recharge the device using the provided solar system or replace the battery.

Remember to always follow the instructions provided by Angel Finders and consult the user manual for any additional guidance or troubleshooting.

### Exhibit 2A

[symbol]

1. Attach the GPS tracking device: Attach the small, discreet GPS tracking device to a headstone or place it near the burial site. Ensure that it is securely fastened and will not be easily moved or damaged.

2. Download the mobile application: Search for the Angel Finders mobile application in your device's app store and download it. The app is available for both iOS and Android devices.

3. Create an account: Open the app and create an account using your email address and a secure password. Follow the prompts to complete the account creation process.

4. Connect the GPS tracking device: Once your account is set up, follow the instructions provided in the app to connect the GPS tracking device to your account. This may involve scanning a QR code or entering a unique identifier.

5. Access the cemetery database: Once the GPS tracking device is connected, you can access the cemetery database through the mobile application. The database will contain the coordinates of each grave.

6. Search for your loved one's grave: Use the interactive cemetery directory in the app to search for your loved one's grave. You can enter their name in the search bar or browse through the cemetery map to locate the specific area.

7. Receive real-time location information: Once you have found the grave, the app will provide real-time location information. It may show the distance to the grave or provide a map with a pin indicating the exact location.

8. Set up customized notifications: In the app settings, you can set up customized notifications to receive alerts when you are approaching your loved one's grave. This can help you navigate the cemetery more easily and ensure you are in the right area.

9. Maintain the GPS tracking device: The GPS tracking device is designed to operate efficiently and has a long battery life. However, it is important to regularly check the device's battery level and ensure it is functioning properly. If needed, recharge the device using the provided solar system or replace the battery. Remember to always follow the instructions provided by Angel Finders and consult the user manual for any additional guidance or troubleshooting.
